(19) United States
(12) Patent Application Publication
(10) Pub. No.: US 2003/0108398 A1
(43) Pub. Date: Jun. 12, 2003

(54) Bolt Assembly

(76) Inventor: Sivasubramanium K. Sathianathan, Burton on Trent (GB)

Correspondence Address: MANELLI DENISON & SELTER, 2000 M STREET NW SUITE 700, WASHINGTON, DC, 20036-3307, US

(21) Appl. No.: 10/303,764

(22) Filed: Nov. 26, 2002

(30) Foreign Application Priority Data
Dec. 11, 2001 (GB) 0129679.7

(51) Int. Cl. F16B 13/06

(52) U.S. Cl. 411/60.1

(57) ABSTRACT

A bolt assembly (22) for securing together members (10, 12, 14) having generally planar abutting surfaces, the bolt assembly (22) comprising a main axis (46), a tapered pin (24), a bush (32), and a means to supply an axial force; the tapered pin (24) comprises a narrow end (26), and a distal end (54); the bush (32) is defined by a generally annular wall (40) and, in use, is disposed substantially within coaxial holes (16, 18, 20) defined in the members (10, 12, 14) and surrounds the tapered pin (24); wherein the bush (32) is radially expandable so that when the means to supply an axial force is employed the tapered pin (24) is drawn into the bush (32) in the direction towards the narrow end (26) from the distal end (54) and thereby radially outwardly expands the bush (32), relative to the main axis (46), to abut the members (16, 18, 20) and substantially prevent relative movement between the members (16, 18, 20).

The present invention relates to a bolt assembly.

It is well known to use a conventional bolt assembly to secure plates together, however, intrinsically the bolt diameter is less than that of the bolt hole. In an aero-engine, for example, thermal cycling and vibrational movements of the plates relative to one another cause frettage of plate and bolt contacting surfaces that may lead to subsequent failure thereof.

Accordingly the present invention seeks to provide a bolt assembly for securing plates together through generally coaxial holes defined therein, the bolt assembly comprising a main axis, a nut, a tapered pin, and a bush, the tapered pin comprises a narrow end, a distal end and a threaded portion, the threaded portion extends from the narrow end and is configured to engage the nut in conventional fashion, the bush is defined by a generally annular wall and, in use, is disposed substantially within the holes and surrounds the tapered pin and the nut abuts the bush, wherein the bush is expandable so that when the threaded portion is tightened to the nut the tapered pin is drawn into the bush in the direction towards the narrow end from the distal end and thereby radially outwardly expanding the bush, relative to the main axis, to abut the plates and substantially prevent relative movement between the plates.

Preferably, the generally annular wall comprises a radially inner surface and a radially outer surface, the annular wall configured so that the diameter to the radially inner surface reduces in diameter from the distal end towards the narrow end.

Preferably, the reduction in diameter to the radially inner surface is substantially the same as the taper of the tapering pin.

Preferably, the radially outer surface is substantially parallel with the main axis. Alternatively, the radially outer surface reduces in diameter from the distal end towards the narrow end.

Preferably, the expandable bush comprises a collar, the collar is disposed about the narrow end and, in use, provides a seat for the bush against a plate.

Preferably, the expandable bush comprises a second collar, the second collar is disposed about the distal end and, in use, provides a seat for the bush against a plate. Preferably, the collar is castellated.

Preferably, the wall defines a gap and the gap extends the entire axial length of the bush. Alternatively, the gap extends between the distal end of the bush and the narrow end. Preferably, the gap is aligned substantially axially. Alternatively, the gap is generally helical. Alternatively, the gap tapers in the direction towards the narrow end. Alternatively, the wall of the bush defines more than one gap.

Alternatively, the bush comprises a resilient material capable of being elastically or plastically deformed laterally by the tapered pin.

Preferably, the tapered pin is hollow and comprises a means for rotating or preventing rotation thereof.

The bolt assembly secures together at least two or alternatively more than two plates are secured together.

Preferably, a washer is disposed, in use, between the nut and the narrow end of the bush.

The present invention will be more fully described by way of example with reference to the accompanying drawings in which:—

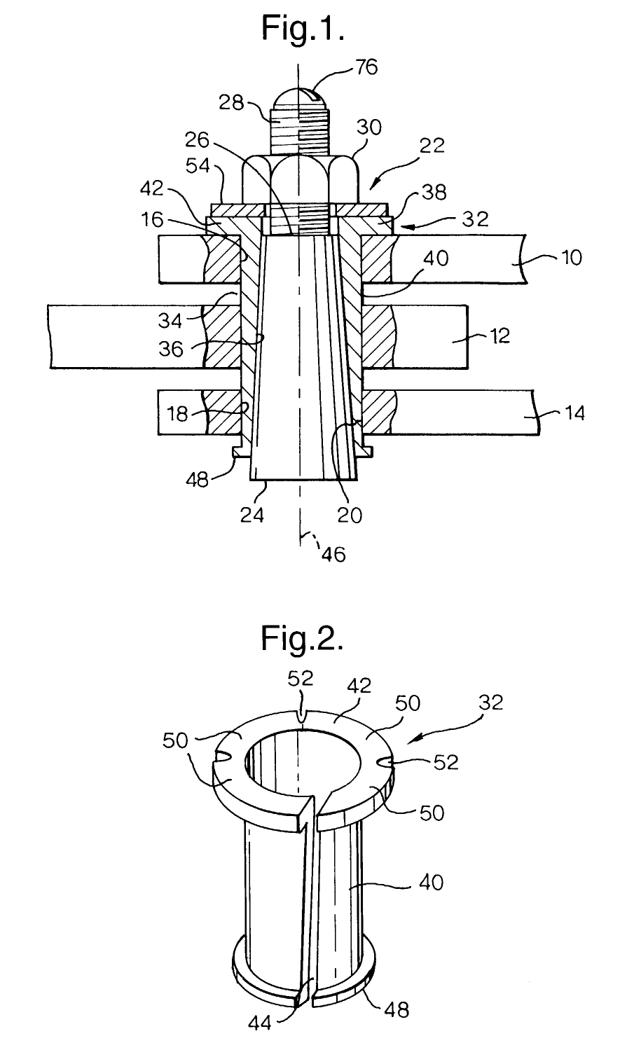

FIG. 1 is cross section of a bolt assembly in accordance with the present invention;

FIG. 2 is an isometric view of a split bush of a bolt assembly shown in FIG. 1;

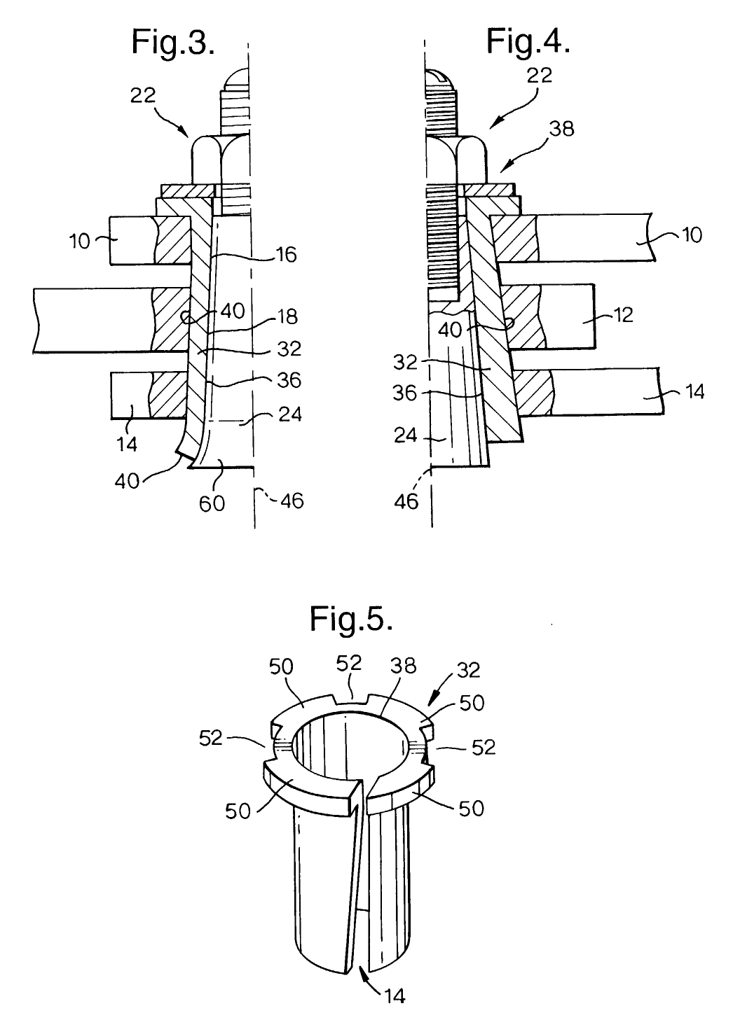

FIG. 3 is part cross section of a second embodiment of a bolt assembly in accordance with the present invention;

FIG. 4 is part cross section of a third embodiment of a bolt assembly in accordance with the present invention;

FIG. 5 is an isometric view of a second embodiment of a split bush of a bolt assembly in accordance with the present invention;

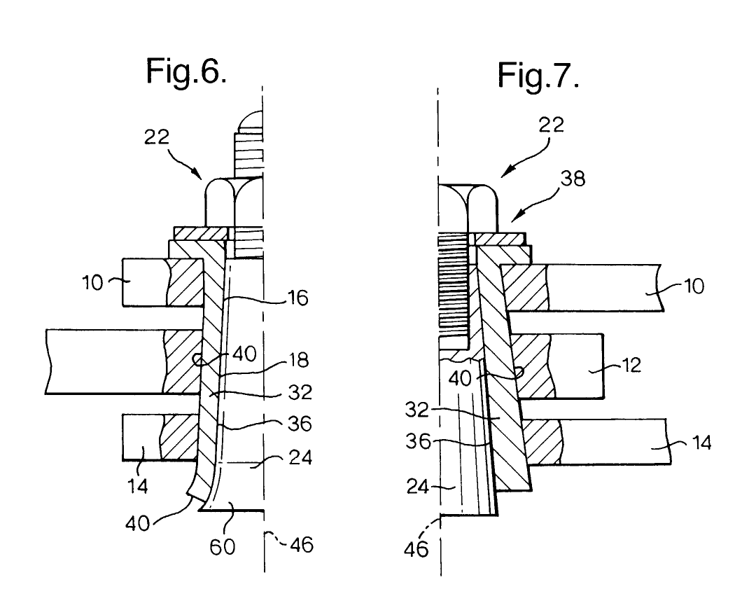

FIG. 6 is part cross section of a fourth embodiment of a bolt assembly in accordance with the present invention;

FIG. 7 is part cross section of a fifth embodiment of a bolt assembly in accordance with the present invention.

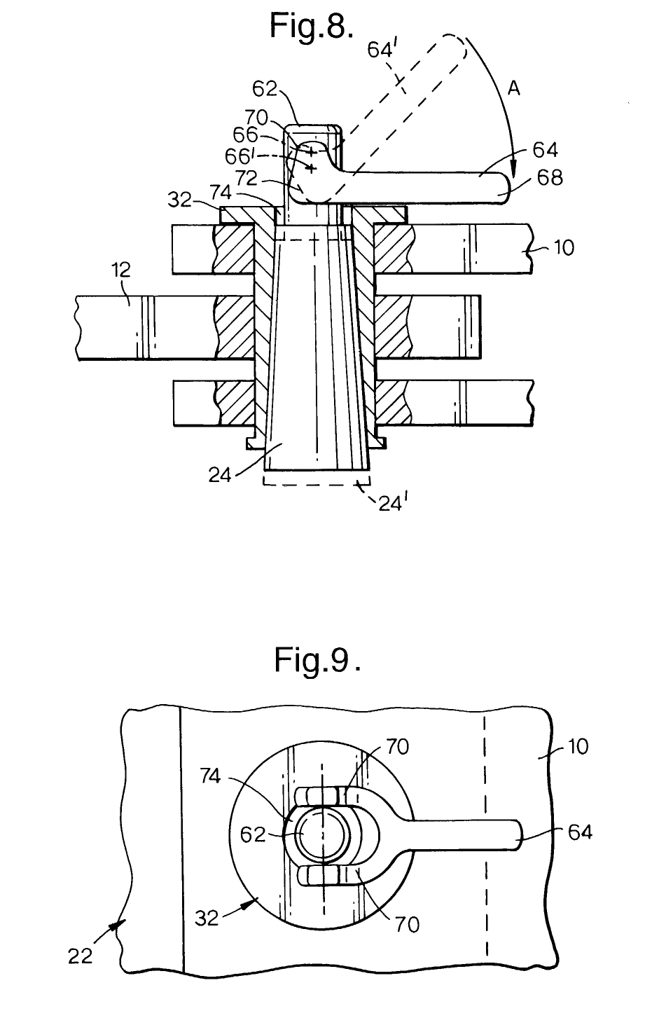

FIG. 8 is a part cross section of a sixth embodiment of a bolt assembly in accordance with the present invention.

FIG. 9 is a top view of the sixth embodiment of a bolt assembly shown in FIG. 8.

With reference to FIG. 1, it is desired to secure together members 10, 12, 14 which comprise planar abutting surfaces via a bolt assembly 22. In this exemplary embodiment the members are plates 10, 12 and 14. The plates 10, 12 and 14 define holes 16, 18 and 20 respectively, which are generally co-axial about a main centre axis 46 so that the bolt assembly 22, in accordance with the present invention, may generally extend therethrough and secure the plates 10, 12 and 14 together.

The bolt assembly 22 comprises a tapered pin 24, which tapers towards a narrow end 26. A threaded portion 28 extends from the narrow end 26 to, in use, engage a complimentary nut 30 in conventional fashion. The bolt assembly 22 further comprises an expandable bush 32, the expandable bush 32 itself is defined in part by a wall 40 having internal and external surfaces 36 and 34 respectively. In this embodiment the diameter to the external surface 34 of the expandable bush 32 is substantially constant and parallel with the main axis 46. The diameter to the internal surface 36, of the expandable bush 32 reduces towards a first end 38 from a distal end 54. Thus it can be seen that the thickness of the wall 40 tapers in the direction towards the distal end 54 from the first end 38.

The bush 32 further comprises a collar 42 which generally extends perpendicular to and outward of the wall 40 and substantially surrounds the first end 38. The collar 42 positively locates or seats the bush 32 against the plate 10. The taper of the expandable bush 32 and the taper of the tapered pin 24 are generally similar.

The bolt assembly 22 is assembled by first inserting the expandable bush 32 through the holes 16, 18 and 20 so that the collar 42 seats on plate 10. The tapered pin 24 is then inserted within the bush 32 so that the nut 30 may engage the threaded portion 28. As the nut 30 and threaded portion 28 are relatively rotated to tighten in conventional fashion, the tapered pin 24 is drawn further into the bush 32 in the direction from the distal end 54 to the narrow end 26. During this operation the increasing diameter of the tapering shape of the pin 24 forces the wall 40 of the bush 32 radially outward to abut against the plates 10, 12 and 14. In this way variations of dimensions of the holes 16, 18, 20 are accommodated by the bolt assembly 22 thereby substantially preventing the plates from relative movement therebetween which may cause frettage of contacting surfaces.

It should be appreciated by one skilled in the art that the nut 30 and threaded portion 28 operate as a means to supply an axial force to the tapered pin 24 and that there are many other ways to accomplish this, one further way is described below.

The bolt assembly 22 may be alternatively assembled as a unitary assembly with the nut 30 only partially being threaded onto the threaded portion 28. In this way the tapered pin 24 is loose in the bush 32 and the bush 32 may be squeezed radially inwardly and inserted through the holes 16, 18, 20. This is a particularly advantageous way of fitting the assembly 22 to the plates 10, 12, 14 where access is difficult or blind.

In this embodiment, and as shown in FIG. 2, the bush 32 is not completely annular, the wall 42 defining a gap 44. In this way the bush 32 is relatively easy to expand radially outwardly, relative to the main axis 46, to engage the plates 10, 12 and 14. Similarly, the bush 32 may be manually squeezed radially inwardly to reduce the diameter thereof so that fitting of the bush through the holes 16, 18 and 20 may be accomplished more easily. This is particularly useful where the expandable bush 32 is provided with a second collar 48. The second collar 48 extends radially outwardly a distance, which is such that when the bush 32 is squeezed inwardly the outer diameter of the second collar 48 is less than that of the holes 16, 18, 20. When the bush 32 is inserted and released the second collar 48 prevents the bush 32 from freely sliding out from the holes 16, 18 and 20 of the plates 10, 12 and 14.

It should be noted that the present invention may be used to secure together two plates, say plates 10 and 12 or more than three plates.

The bolt assembly 22 also comprises a washer 54 disposed between the nut 30 and the first end 26 of the tapered pin 24. The washer 54 operates in conventional fashion as known in the art.

Although the present invention describes the bush 24 having a gap 44, it is intended that the function of the bush 32 is such that when assembled the tapered pin 22 the bush 32 is expanded radially outwardly by the tapered pin 24 to engage the plates 10, 12 and 14. The bush 32 may therefore comprise a resilient material which is elestically or plastically deformable. Such a resilient material may be chosen from the group comprising metals, plastics and composites.

Either collar 42, 48 of the bush 32 may alternatively comprise arcuate portions 50 having spaces 52 therebetween thus forming a castellated collar 42, 48. This can be seen more clearly on FIG. 5. As the collars 42, 48 principally provide a positive location for the bush 32 it is desirable for the collars 42, 48 of the bush 32 not to inhibit flexibility of the bush 32 when manually or otherwise squeezed for insertion to the holes 16, 18, 20.

The tapered pin 24 further defines means for rotating or preventing rotation thereof during assembly. The means for rotating or preventing rotation comprises a slit 54 at the free end of the threaded portion 28, which is configured so that a conventional screwdriver may engage the slit 54 to prevent the pin 24 from rotating while the nut 30 is threaded thereon. The means for rotating or preventing rotation may alternatively comprise any compatible configuration for engagement with conventional heads of rotational tools.

Although FIG. 1 shows the holes 16, 18, 20 having a nominally similar diameter the present invention could be equally be used where each plate defines differently sized holes. FIGS. 3 and 4 show holes 16, 18, 20 comprising different diameters. The variation in diameters is accommodated by the wall thickness either being constant as shown in FIG. 3 or increasing in thickness in the direction away from the first end 38. It should be noted that the diameter of the inner surface of the wall 40 of the bush 32 is tapered towards the first end 38 and is configured for operative association with the tapered pin 24.

It is a further advantage of these two embodiments of the bush 32 that the outer surface 34 is also tapered towards the first end 38 as the increase in diameter helps to locate the bush 32 in the holes 16, 18, 20 preventing the bush 32 from being pushed out when the tapered pin 24 is inserted. In these embodiments the second collar (48 in FIG. 2) is not necessarily required. However, to successfully insert the expandable bush 32 into the holes 16, 18, 20 the gap 44 is required to increase in width in the direction away from the first end 38. The gap 44 is of a sufficient width to enable the diameter of the wall 40 to be reduced to less than that of the smallest hole 16. Although the gap 44 shown in FIG. 5 is generally axially aligned the gap 44 may also be substantially helical about the wall 40.

Referring now to FIG. 6, in an alternative embodiment of the present invention, the tapered pin 24 comprises a bell-shaped portion 60. The purpose of the bell-shaped portion 60 is to deform the walls 40 of the bush 32 as the tapered pin 24 is drawn into the bush 32. By deforming the bush 32 in this way the assembly is secured within the holes 16, 18, 20.

Referring to FIG. 7, in an alternative embodiment of the present invention, the nut (30) is replaced by a threaded bolt 56, which, during assembly, is threaded into a complimentarily threaded hole 58 defined in the tapered pin 24. The method of assembly and general functionality of this embodiment is in accordance with the present invention.

Referring to FIGS. 8 and 9, an alternative embodiment of the bolt assembly 22 comprises a further means to supply an axial force to the tapered pin 24. In this example, a projection 62 extends axially from the narrow end 26 of the pin 24. A generally L-shaped lever 64 is pivotably mounted at 66 to the projection 62 via a short arm 70 of the lever 64. The lever 64 further comprises a lever arm 68 and an apex 72. In operation and in a first position as shown by the dashed lines the lever 64′ is rotated about the rotatable mount 66 in the direction of arrrow to its second position 64 shown by the solid lines. During this operation, the apex 72 abuts the bush 32 to provide a reaction force Lo the projection 62. In so doing the tapered pin 24′ is drawn into the bush 32 in the direction towards its narrow end 26 from its distal end 54 and thereby radially outwardly expanding the bush 32, relative to the main axis, to abut the planar members 10, 12, 14 and substantially prevent relative movement between the members 10, 12, 14.

A washer (not shown but similar to 54 in FIG. 1) may be disposed between the apex 72 and the bush 24 to provide an improved reaction surface and to bridge a gap 74 defined between the projection 62 and the bush 32.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I claim

1. A bolt assembly for securing together members having generally planar abutting surfaces, the bolt assembly comprising a main axis, a tapered pin, a bush, and a means to supply an axial force; the tapered pin comprises a narrow end, and a distal end; the bush is defined by a generally annular wall and, in use, is disposed substantially within coaxial holes defined in the members and surrounds the tapered pin; wherein the bush is radially expandable so that when the means to supply an axial force is employed the tapered pin is drawn into the bush in the direction towards the narrow end from the distal end and thereby radially outwardly expands the bush, relative to the main axis, to abut the members and substantially prevent relative movement between the members.

2. A bolt assembly as claimed in claim 1 wherein the assembly comprises a threaded portion and a nut, the threaded portion extends from the narrow end of the tapered pin and is configured to engage the nut in conventional fashion, in use, the nut abuts the bush and when it is tightened to the threaded portion provides the means to supply an axial force to the tapered pin.

3. A bolt assembly as claimed in claim 1 wherein the assembly comprises a projection and a lever, the projection extends from the narrow end of the tapered pin; the lever is generally L-shaped and comprises a short arm, a lever arm and an apex, the short arm is rotatably mounted to the projection so that in use when the lever is forced from a first position to a second position the apex abuts the bush and thereby provides the means to supply an axial force to the tapered pin.

4. A bolt assembly as claimed in claim 1 wherein the generally annular wall comprises a radially inner surface and a radially outer surface, the surface is configured to taper from the distal end towards the narrow end.

5. A bolt assembly as claimed in claim 3 wherein the taper of the radially inner surface is complimentary to the taper of the tapering pin.

6. A bolt assembly as claimed in claim 4 wherein the radially outer surface is substantially parallel with the main axis.

7. A bolt assembly as claimed in claim 4 wherein the radially outer surface reduces in diameter from the distal end towards the narrow end.

8. A bolt assembly as claimed in claim 1 wherein the expandable bush comprises a collar, the collar is disposed about the narrow end and, in use, provides a seat for the bush against a plate.

9. A bolt assembly as claimed in claim 1 wherein the expandable bush comprises a second collar, the second collar is disposed about the distal end and, in use, provides a seat for the bush against a plate.

10. A bolt assembly as claimed in claim 8 wherein the collar is castellated.

11. A bolt assembly as claimed in claim 1 wherein the wall defines a gap and the gap extends the entire axial length of the bush.

12. A bolt assembly as claimed in claim 1 wherein the wall defines a gap and the gap extends between the distal end of the bush and the narrow end.

13. A bolt assembly as claimed in claim 11 wherein the gap is aligned substantially axially.

14. A bolt assembly as claimed in claim 11 wherein the gap is generally helical.

15. A bolt assembly as claimed in claim 10 wherein the gap tapers in the direction towards the narrow end.

16. A bolt assembly as claimed in claim 12 wherein the wall of the bush defines more than one gap.

17. A bolt assembly as claimed in claim 1 wherein the bush comprises a resilient material capable of being elastically or plastically deformed laterally by the tapered pin.

18. A bolt assembly as claimed in claim 1 wherein the tapered pin is hollow.

19. A bolt assembly as claimed in claim 1 wherein the tapered pin comprises a means for rotating or preventing rotation thereof.

20. A bolt assembly as claimed in claim 1 wherein two or more plates are secured together.

21. A bolt assembly as claimed in claim 1 wherein a washer is disposed, in use, between the nut and the narrow end of the bush.

22. A bolt assembly as claimed in claim 1 wherein the tapered pin comprises a bell-shaped portion, the bell-shaped portion is configured to deform the bush at its distal end to secure the assembly in the holes.
